(19) United States
(12) Patent Application Publication
(10) Pub. No.: US 2019/0042460 A1
(43) Pub. Date: Feb. 7, 2019

(54) METHOD AND APPARATUS TO ACCELERATE SHUTDOWN AND STARTUP OF A SOLID-STATE DRIVE

(71) Applicant: Intel Corporation, Santa Clara, CA (US)

(72) Inventors: Sanjeev N. TRIKA, Portland, OR (US); Rowel S. GARCIA, North Plains, OR (US)

(21) Appl. No.: 15/891,073

(22) Filed: Feb. 7, 2018

(51) Int. Cl. G06F 12/1009

(52) U.S. Cl. CPC G06F 12/1009; G06F 2212/657; G06F 2212/2022; G06F 2212/1016

(57) ABSTRACT

A computer system that includes a host based byte addressable persistent buffer to store a Logical to Physical (L2P) indirection table for a solid-state drive is provided. Shutdown and startup of the computer system is accelerated by storing the L2P indirection table in the host based byte addressable persistent buffer.

### FIELD

This disclosure relates to computer systems and in particular to shutdown and startup of a solid-state drive.

### BACKGROUND

Volatile memory is memory whose state (and therefore the data stored in it) is indeterminate if power is interrupted to the device. Nonvolatile memory refers to memory whose state is determinate even if power is interrupted to the device. Dynamic volatile memory requires refreshing the data stored in the device to maintain state.

A computer system typically includes a volatile system memory, for example, a Dynamic Random Access Memory (DRAM) and a storage device, for example, a Solid-state Drive (SSD) that includes block addressable non-volatile memory. A logical block is the smallest addressable data unit for read and write commands to access the block addressable non-volatile memory in the Solid-state Drive (SSD). The address of the logical block is commonly referred to as a Logical Block Address (LBA). A logical-to-physical (L2P) indirection table stores a physical block address in block addressable non-volatile memory in the SSD corresponding to each LBA. The size of the L2P indirection table is dependent on the user-capacity of the SSD. Typically, the size of the L2P indirection table is about one Mega Byte(MB) per Giga Byte (GB) of user-capacity in the SSD.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 is a block diagram of an embodiment of a computer system that includes a persistent host buffer to accelerate startup and shutdown of the computer system;

FIG. 2A is an example of a drive state for the SSD shown in FIG. 1;

FIG. 2B is an example of a L2P indirection table in the drive state shown in FIG. 2A;

FIG. 3 is a block diagram illustrating the use of persistent and volatile (“non-persistent”) memory in the system shown in FIG. 1 to store the L2P indirection table;

FIG. 4 is a flowchart illustrating a write request to write data to non-volatile memory in the SSD; and

FIG. 5 is a flowchart illustrating a read request to read data from non-volatile memory in the SSD.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly and be defined only as set forth in the accompanying claims.

### DESCRIPTION OF EMBODIMENTS

After electrical power is applied to the computer system, the computer system is initialized using a process commonly referred to as system boot. The system boot process typically includes performing a power-on self-test, locating and initializing the storage device, and loading and starting an operating system.

During the boot process, the L2P indirection table is read from the block addressable non-volatile memory in the SSD and written to a byte addressable volatile memory. The byte addressable volatile memory may be in the SSD or be a portion of the system memory.

During runtime, the L2P indirection table stored in byte addressable volatile memory is modified, for example, to write a physical block address in the block addressable non-volatile memory in the SSD corresponding to an LBA. As the L2P indirection table is stored in volatile memory, it must be stored to block addressable non-volatile memory in the SSD when the computer system is being shutdown or hibernated and restored on a subsequent system startup. The time to write the large L2P indirection table to the block addressable non-volatile memory in the SSD prior to shutdown/hibernation and to read the large L2P indirection table from block addressable non-volatile memory during restore and boot increases shutdown, hibernation, restore and boot times for the computer system. In addition, if there is insufficient time to write the L2P indirection table to block addressable non-volatile in the SSD, for example, if there is a power-loss or operating system crash, the time required by the SSD to rebuild the L2P indirection table results in a large increase in system boot time. To avoid the large increase in system boot time, the L2P indirection table in the block addressable non-volatile memory in the SSD may be periodically updated but this may result in reduced performance and quality of service for applications using the SSD.

In an embodiment, the system memory includes a persistent (byte-addressable write-in-place non-volatile) memory and at least a portion of the L2P indirection table for the SSD is stored in the persistent system memory.

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

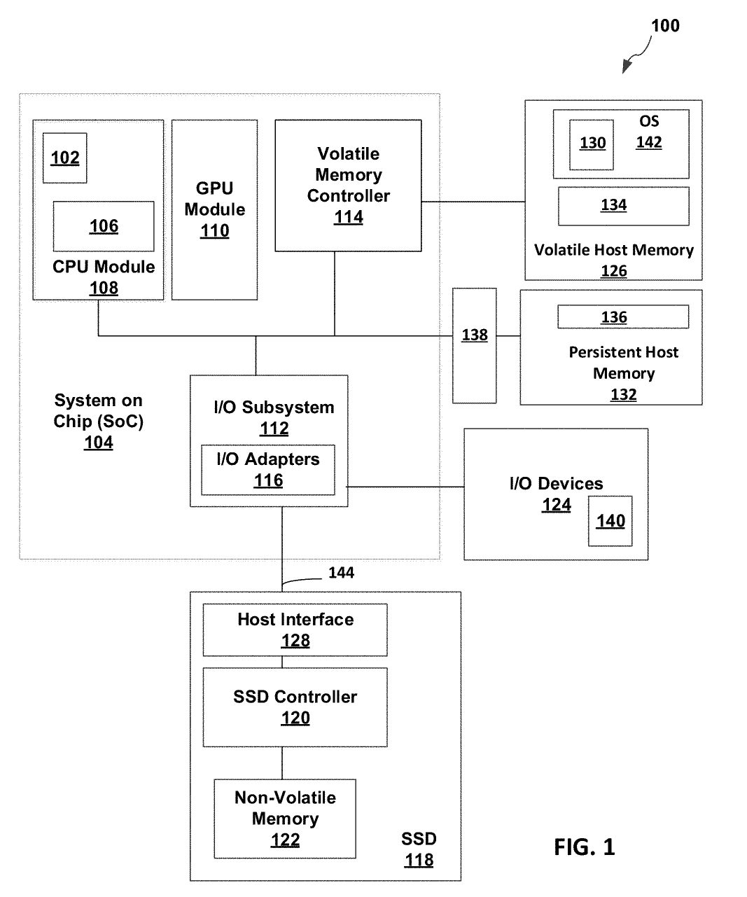

FIG. 1 is a block diagram of an embodiment of a computer system 100 that includes a persistent host memory buffer 136 to accelerate startup and shutdown of a solid-state drive in the computer system 100. The persistent host memory buffer 136 may be referred to as a persistent system memory buffer or a persistent host memory buffer. Computer system 100 may correspond to a computing device including, but not limited to, a server, a workstation computer, a desktop computer, a laptop computer, and/or a tablet computer.

The computer system 100 includes a system on chip (SOC or SoC) 104 which combines processor, graphics, memory, and Input/Output (I/O) control logic into one SoC package. The SoC 104 includes at least one Central Processing Unit (CPU) module 108, a volatile memory controller 114, and a Graphics Processor Unit (GPU) 110. In other embodiments, the volatile memory controller 114 may be external to the SoC 104. Although not shown, each of the processor core(s) 102 may internally include one or more instruction/data caches, execution units, prefetch buffers, instruction queues, branch address calculation units, instruction decoders, floating point units, retirement units, etc. The CPU module 108 may correspond to a single core or a multi-core general purpose processor, such as those provided by Intel® Corporation, according to one embodiment.

The Graphics Processor Unit (GPU) 110 may include one or more GPU cores and a GPU cache which may store graphics related data for the GPU core. The GPU core may internally include one or more execution units and one or more instruction and data caches. Additionally, the Graphics Processor Unit (GPU) 110 may contain other graphics logic units that are not shown in FIG. 1, such as one or more vertex processing units, rasterization units, media processing units, and codecs.

Within the I/O subsystem 112, one or more I/O adapter(s) 116 are present to translate a host communication protocol utilized within the processor core(s) 102 to a protocol compatible with particular I/O devices. Some of the protocols that adapters may be utilized for translation include Peripheral Component Interconnect (PCI)-Express (PCIe); Universal Serial Bus (USB); Serial Advanced Technology Attachment (SATA) and Institute of Electrical and Electronics Engineers (IEEE) 1594 “Firewire”.

The I/O adapter(s) 116 may communicate with external I/O devices 124 which may include, for example, user interface device(s) including a display and/or a touch-screen display 140, printer, keypad, keyboard, communication logic, wired and/or wireless, storage device(s) including hard disk drives (“HDD”), solid-state drives (“SSD”), removable storage media, Digital Video Disk (DVD) drive, Compact Disk (CD) drive, Redundant Array of Independent Disks (RAID), tape drive or other storage device. The storage devices may be communicatively and/or physically coupled together through one or more buses using one or more of a variety of protocols including, but not limited to, SAS (Serial Attached SCSI (Small Computer System Interface)), PCIe (Peripheral Component Interconnect Express), NVMe (NVM Express) over PCIe (Peripheral Component Interconnect Express), and SATA (Serial ATA (Advanced Technology Attachment)).

Additionally, there may be one or more wireless protocol I/O adapters. Examples of wireless protocols, among others, are used in personal area networks, such as IEEE 802.15 and Bluetooth, 4.0; wireless local area networks, such as IEEE 802.11-based wireless protocols; and cellular protocols. The I/O adapter(s) may also communicate with a solid-state drive (“SSD”) 118 which includes a SSD controller 120, a host interface 128 and block addressable non-volatile memory 122 that includes one or more non-volatile memory devices.

The I/O adapters 116 may include a Peripheral Component Interconnect Express (PCIe) adapter that is communicatively coupled using the NVMe (NVM Express) over PCIe (Peripheral Component Interconnect Express) protocol over bus 144 to a host interface 128 in the SSD 118. Non-Volatile Memory Express (NVMe) standards define a register level interface for host software to communicate with a non-volatile memory subsystem (for example, a Solid-state Drive (SSD)) over Peripheral Component Interconnect Express (PCIe), a high-speed serial computer expansion bus. The NVM Express standards are available at www.nvmexpress.org. The PCIe standards are available at www.pcisig.com.

The system also includes a persistent host memory 132 and a persistent memory controller 138 communicatively coupled to the CPU module 108 in the SoC 104. The persistent host memory 132 is a byte addressable write-in-place non-volatile memory.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also include a byte-addressable write-in-place three dimensional crosspoint memory device, or other byte addressable write-in-place NVM devices (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

An operating system (OS) 142 that includes a storage stack 130 may be stored in volatile host memory 126. In an embodiment, a portion of the volatile host memory 126 may be reserved for the L2P indirection table 200.

Volatile memory is memory whose state (and therefore the data stored in it) is indeterminate if power is interrupted to the device. Dynamic volatile memory requires refreshing the data stored in the device to maintain state. One example of dynamic volatile memory includes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory, JESD325, originally published by JEDEC in October 2013, DDR5 (DDR version 5, currently in discussion by JEDEC), LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

An operating system 142 is software that manages computer hardware and software including memory allocation and access to I/O devices. Examples of operating systems include Microsoft® Windows®, Linux®, iOS® and Android®. In an embodiment for the Microsoft® Windows® operating system, the storage stack 130 may be a device stack that includes a port/miniport driver for the SSD 118.

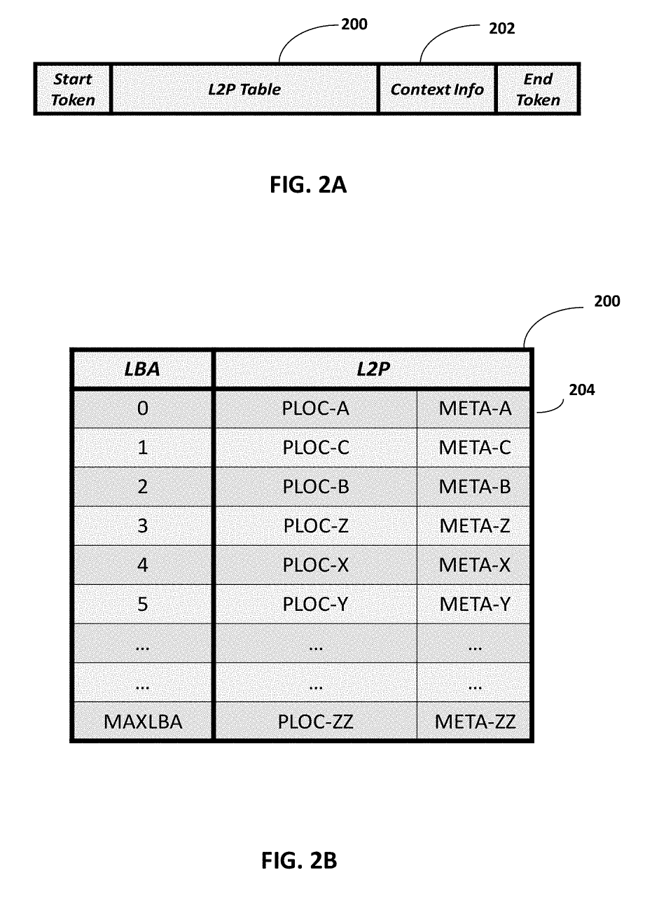

FIG. 2A is an example of a drive state for the SSD 118 shown in FIG. 1. The drive state may include a start token that marks the beginning of the drive state and an end token that marks the end of the drive state. The drive state also includes a L2P indirection table 200 and context information 202 that may include context size, timestamps, band information, a validity table and sequence numbers that may be used to keep the L2P indirection table 200 coherent.

FIG. 2B is an example of the L2P indirection table 200 shown in FIG. 2A that may be stored in the persistent system memory shown in FIG. 1. Each entry (“row”) 204 in the L2P indirection table 200 includes a Logical Block Address (LBA), a physical location (“PLOC”) in the block addressable non-volatile memory 122 in the SSD 118 that corresponds to the Logical Block Address (LBA) and metadata (META). In an embodiment in which the block addressable non-volatile memory 122 in the SSD 118 includes one or more NAND Flash dies, a PLOC is the physical location in the one or more NAND Flash dies where data is stored for a particular LBA, for example, in row 204, physical location A (“PLOC-A”) corresponding to LBA 0 may be NAND Flash die-0, block-1, page-1, offset-0.

Metadata is data that provides information about other data. For example, one bit of the metadata may be a “dirty bit”, the state of which indicates whether the user data for the entry 202 has not been flushed from the persistent host memory buffer to volatile host memory buffer 136 or block addressable non-volatile memory 122, another bit of the metadata may be a “lock bit” to prevent read/write access to the PLOC in the L2P entry in the L2P indirection table 200.

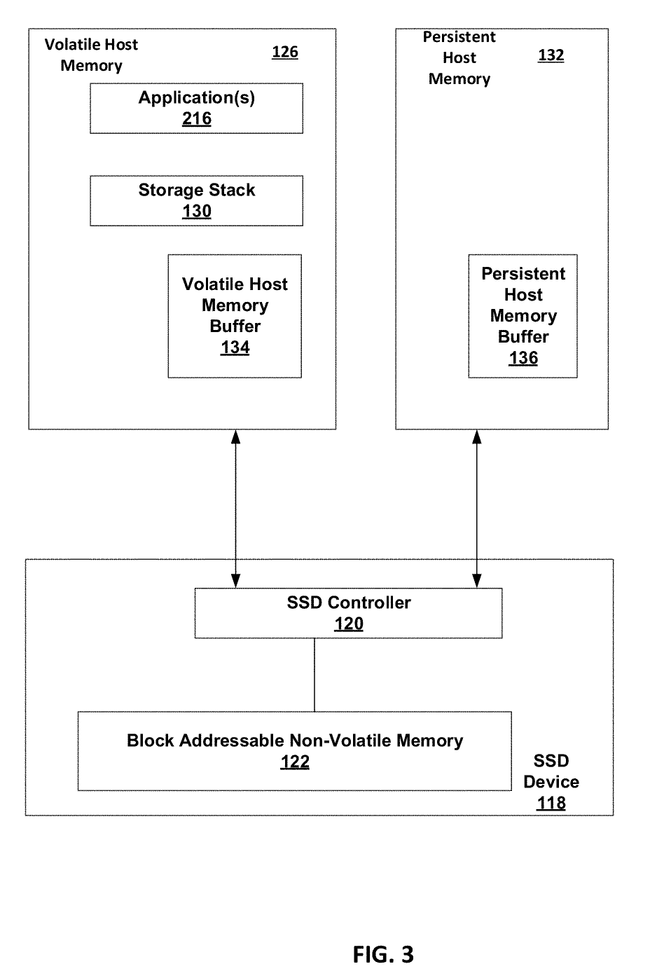

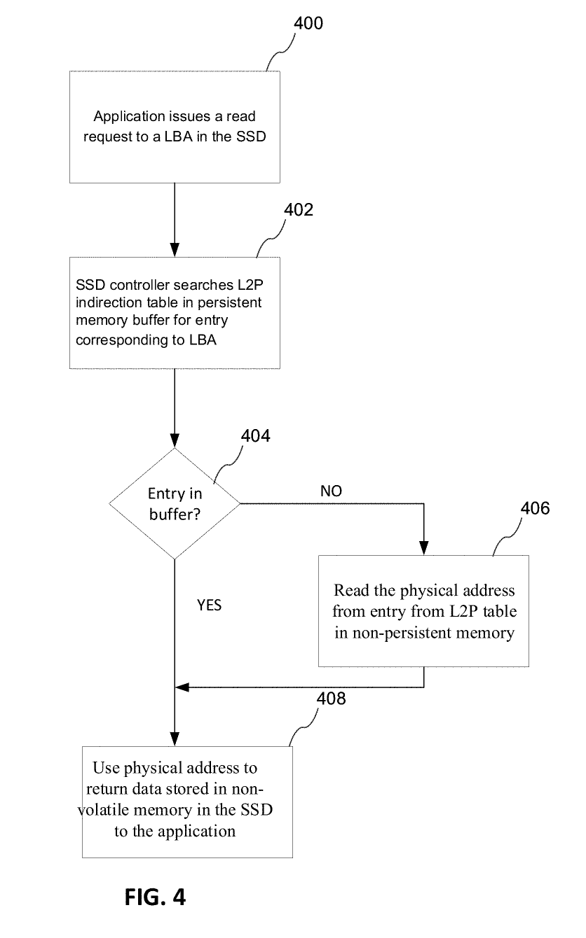

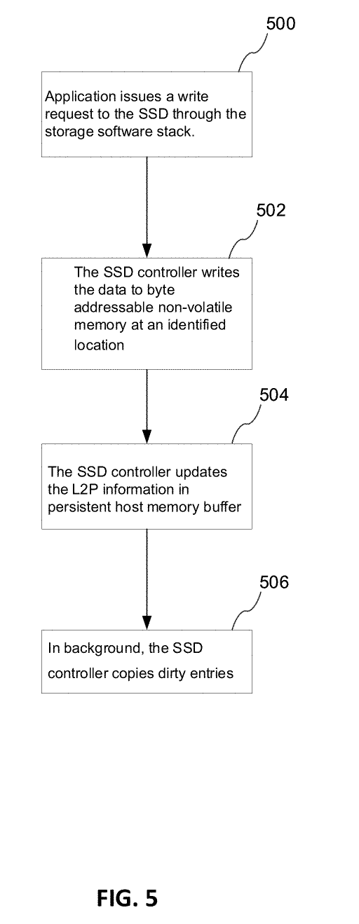

FIG. 3 is a block diagram illustrating the use of persistent and volatile (“non-persistent”) memory in the computer system 100 shown in FIG. 1 to store the L2P indirection table 200. FIG. 4 is a flowchart illustrating a write request to write data to block addressable non-volatile memory 122 in the SSD 118. FIG. 5 is a flowchart illustrating a read request to read data from block addressable non-volatile memory 122 in the SSD 118. FIG. 3 will be described in conjunction with FIG. 4 and FIG. 5.

Turning to FIG. 3, one or more applications 302 (programs that perform a particular task or set of tasks), the storage stack 130 and a volatile host memory buffer 134 may be stored in volatile host memory 126. The volatile host memory buffer 134 may be a portion of volatile host memory 126 that is assigned for exclusive use by the SSD controller 120. The persistent host memory buffer 136 may be a portion of persistent host memory 132 that is assigned for exclusive use by the SSD controller 120.

In an embodiment in which the SSD 118 communicatively coupled to the volatile host memory 126 and persistent host memory 132 using the NVMe over PCIe protocol, host software may provide a descriptor list that describes a set of host memory ranges for exclusive use by the SSD controller 120. The persistent host memory buffer 136 and volatile host memory buffer 134 assigned are for the exclusive use of the SSD controller 120 until the SSD controller 120 releases them via an NVMe Set Features command. In an embodiment, the size of the persistent host buffer 136 that is assigned for exclusive use by the SSD controller 120 is sufficient to store the entire L2P indirection table and the volatile host memory buffer 134 in volatile memory is not needed.

In an embodiment, in which the size of the persistent host memory buffer 136 is not sufficient to store the entire L2P indirection table, the persistent host memory buffer 136 acts as a write-back cache for the volatile host memory buffer 134 and the volatile host memory buffer 134 acts as a write-through cache for the L2P indirection table 200 stored in the block addressable non-volatile memory 122 in the SSD 118. For the write-through cache, the write operation is performed synchronously to both the volatile host memory buffer 134 and to the block addressable non-volatile memory 122 in the SSD 118.

For the write back cache, a write operation to the L2P indirection table 200 is initially only performed in the persistent host memory buffer 136 and the entry in the persistent host memory buffer 136 is marked as “dirty” for later writing to block addressable non-volatile memory 122 in the SSD 118 and the volatile host memory buffer 134. Entries in the portion of the L2P indirection table 200 that is stored in the persistent host memory buffer 146 that are marked as “dirty” are flushed (“written”) to both the volatile host memory buffer 134 and the block addressable non-volatile memory 122 in the SSD 118. In order to mitigate potential performance issues due to the writing of these “dirty” entries during runtime, write operations from applications 216 may be prioritized over writes of “dirty” entries and scheduled during relatively-idle times.

A read of an entry in the L2P indirection table 200 is initially directed to the persistent host memory buffer 136. If there is a “hit”, that is, the entry is in the persistent host memory buffer 136 is “clean”, the entry is read from the persistent host memory buffer 136. If there is a “miss”, that is, the entry in the persistent host memory buffer 136 is “dirty”, the entry is read from the portion of the L2P indirection table 200 that is stored in volatile host memory buffer 134. As a performance optimization, both the persistent host memory buffer 136 and the volatile host memory buffer 134 may be read concurrently, and one of the two entries discarded dependent on the state (“dirty” or “clean”) of the entry in the persistent host memory buffer 136.

During the first initialization of the computer system 100, the controller in the SSD requests exclusive use of a portion of persistent host memory 132 in the computer system 100 to store the L2P indirection table 200. If sufficient persistent memory is available in the persistent host memory 132 to store all of the (that is, the entire) L2P indirection table 200 the need to store, a copy of the L2P indirection table 200 in non-volatile memory in the SSD may be eliminated unless the copy is required for backup (for redundancy in case of data corruption in persistent memory) or migration (prior to moving the SSD to another system). If a copy of the L2P indirection table 200 is not stored in the block addressable non-volatile memory 122 in the SSD 118, tasks including background flushes, saving the L2P indirection table in block addressable non-volatile memory 122 and restores/reconstructions of the L2P indirection table 200 from block addressable non-volatile memory 122 are no longer required.

If the persistent host memory buffer 136 that is allocated by the system for use by the SSD controller 120 is not sufficient to store the entire L2P indirection table 200, the SSD controller 120 in the SSD 118 may request additional memory in volatile host memory 126 in the computer system 100. If sufficient persistent memory is not allocated to the persistent host memory buffer 136, the SSD controller 120 uses the allocated persistent host memory buffer 136 as a write-back cache for the L2P indirection table 200 which is stored in both block addressable non-volatile memory 122 in the SSD 118 and in the volatile host memory buffer 134.

After a reset of the computer system 100, the persistent host memory buffer 136 and the volatile host memory buffer 134 that were allocated for exclusive use by the SSD controller 120 to store the L2P indirection table 200 are no longer allocated to the SSD controller 120. On a subsequent initialization of the computer system 100, the SSD controller 120 in the SSD 118 requests the previously allocated persistent host memory buffer 136. The validity of the persistent host memory buffer 136 may be verified using signature checks. A signature may include the SSD's serial number, model number, capacity, and other pertinent information identifying the SSD. For example, the signature may be stored in the persistent host memory buffer 136 and in the block addressable non-volatile memory 122 in the SSD 118 prior to system shutdown and the saved signatures may be verified on power restoration of the computer system 100.

In an embodiment, on power restoration the SSD controller 120 in the SSD 118 may verify the signatures to ensure that the physical location of the persistent host memory buffer 136 in the persistent host memory 132 is the same to ensure that there was no separation of the SSD 118 from the computer system 100 when the computer system 100 was powered down. The SSD 118 may power up fully only when the signatures match.

The load of the L2P indirection table 200 from block addressable non-volatile memory 122 in the SSD 118 to the volatile host memory buffer 134 is required on power-up events. System power up time is reduced because only the portion of the L2P indirection table 200 that is stored in the volatile host memory buffer 134 is read from block addressable non-volatile memory 122 in the SSD 118 and written to the volatile host memory buffer 134. System shutdown time is also reduced because the saving of the portion of the L2P indirection table 200 that is stored in the persistent host memory buffer 136 on power-down/power-fail is no longer required. Complex and expensive Power Loss Recovery (PLR) logic is also eliminated.

Turning to FIG. 4, at block 400, a request to read data stored in block addressable non-volatile memory 122 in the SSD 118 may be issued by one or more applications 302 (programs that perform a particular task or set of tasks) through the storage stack 130 in the operating system to the SSD controller 120. Processing continues with block 402.

At block 402, the SSD controller 120 performs a search in the L2P indirection table in the persistent host memory buffer 136 for an entry corresponding to the logical block address provided in the read request. Processing continues with block 404.

At block 404, if an entry corresponding to the logical block address is in the portion of the L2P indirection table 200 that is stored in the persistent host memory buffer 136, the SSD controller 120 reads the physical block address from the entry and processing continues with block 406. If the entry corresponding to the logical block address is not in the portion of the L2P indirection table 200 that is stored in the persistent host memory buffer 136, that is, there is a “miss”, processing continues with block 406.

At block 406, the SSD controller 120 reads the physical block address from the entry corresponding to the logical block address provided in the read request from the portion of the L2P indirection table 200 that is stored in the volatile host memory buffer 134. Processing continues with block 408.

At block 408, the SSD controller 120 reads the data from the block addressable non-volatile memory 122 in the SSD 118 at the physical location in the block addressable non-volatile memory 122 stored in the entry in the L2P indirection table 200 and returns the data to the application 216 that requested the data through the storage stack 130 in the operating system 142.

Turning to FIG. 5, at block 500, the application 216 issues a write request to a logical block address through the storage stack 130 in the operating system 142 to the SSD controller 120 in the SSD 118 to write data to the block addressable non-volatile memory 122 in the SSD 118. Processing continues with block 502.

At block 502, the SSD controller 120 writes the data at a physical location in the block addressable non-volatile memory 122 in the SSD 118. The physical location (for example, physical location A (“PLOC-A”) corresponding to LBA 0 may be NAND Flash die-0, block-1, page-1, offset-0) may be allocated from a pool of free blocks allocated to the SSD controller 120). Processing continues with block 504.

At block 504, the SSD controller 120 in the SSD 118 creates a new entry in the L2P indirection table 200 for the logical block address included in the write request and writes the physical location in the block addressable non-volatile memory 122 corresponding to the logical block address in the new entry. Processing continues with block 506.

At block 506, in a background task, the SSD controller 120 copies entries from the L2P indirection table 200 stored in the persistent host memory buffer 136 to the volatile host memory buffer 134 and the block addressable non-volatile memory 122 in the SSD 118.

Flow diagrams as illustrated herein provide examples of sequences of various process actions. The flow diagrams can indicate operations to be executed by a software or firmware routine, as well as physical operations. In one embodiment, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

To the extent various operations or functions are described herein, they can be described or defined as software code, instructions, configuration, and/or data. The content can be directly executable (“object” or “executable” form), source code, or difference code (“delta” or “patch” code). The software content of the embodiments described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to the disclosed embodiments and implementations of the invention without departing from their scope.

Therefore, the illustrations and examples herein should be construed in an illustrative, and not a restrictive sense. The scope of the invention should be measured solely by reference to the claims that follow.

What is claimed is:

1. An apparatus comprising:
a persistent host memory buffer; and
a persistent memory controller communicatively coupled to the persistent host memory buffer, the persistent host memory buffer to store a portion of a logical to physical (L2P) indirection table, the L2P indirection table to store a physical location of data stored in a block addressable non-volatile memory in a solid-state drive, the physical location of data assigned to a logical block address used to access data for an application.

2. The apparatus of claim 1, wherein the persistent host memory buffer is a byte-addressable write-in-place non-volatile memory.

3. The apparatus of claim 1, wherein the portion is all of L2P indirection table.

4. The apparatus of claim 1, further comprising:
a volatile host memory buffer to store a second portion of the L2P indirection table.

5. The apparatus of claim 4, wherein the volatile host memory buffer is a write-through cache for the block addressable non-volatile memory.

6. The apparatus of claim 4, wherein the persistent host memory buffer is a write-back cache for the volatile host memory buffer and the block addressable non-volatile memory.

7. The apparatus of claim 1, wherein the block addressable non-volatile memory is NAND Flash.

8. The apparatus of claim 1, wherein the persistent host memory buffer is allocated to a solid-state drive for exclusive use by the solid-state drive.

9. A method comprising:
storing a portion of a logical to physical (L2P) indirection table for a solid-state drive in a persistent host memory buffer; and
storing a physical location of data stored in a block addressable non-volatile memory in the solid-state drive in the L2P indirection table, the physical location of data assigned to a logical block address used to access data for an application.

10. The method of claim 9, wherein the persistent host memory buffer is a byte-addressable write-in-place non-volatile memory.

11. The method of claim 9, wherein the portion is all of L2P indirection table.

12. The method of claim 9, further comprising:
a volatile host memory buffer to store a second portion of the L2P indirection table.

13. The method of claim 12, wherein the volatile host memory buffer is a write-through cache for the block addressable non-volatile memory.

14. The method of claim 13, wherein the persistent host memory buffer is a write-back cache for the volatile host memory buffer and the block addressable non-volatile memory.

15. The method of claim 9, wherein the block addressable non-volatile memory is NAND Flash.

16. The method of claim 9, wherein the persistent host memory buffer is allocated to the solid-state drive for exclusive use by the solid-state drive.

17. A system comprising:
a persistent host memory buffer;
a solid-state drive communicatively coupled to the persistent host memory buffer, the persistent host memory buffer to store a portion of a logical to physical (L2P) indirection table, the L2P indirection table to store a physical location of data stored in a block addressable non-volatile memory in the solid-state drive, the physical location of data assigned to a logical block address used to access data for an application; and
a display communicatively coupled to a processor to display data stored in the block addressable non-volatile memory in the solid-state drive.

18. The system of claim 17, wherein the persistent host memory buffer is a byte-addressable write-in-place non-volatile memory.

19. The system of claim 17, wherein the portion is all of the L2P indirection table.

20. The system of claim 17, wherein the block addressable non-volatile memory is NAND Flash.

21. The system of claim 17, wherein the persistent host memory buffer is allocated for exclusive use by the solid-state drive.

22. At least one non-transitory computer-readable storage medium comprising instructions that, when executed cause a system to:
store a portion of a logical to physical (L2P) indirection table for a solid-state drive in a persistent host memory buffer; and
store a physical location of data stored in a block addressable non-volatile memory in the solid-state drive in the L2P indirection table, the physical location of data assigned to a logical block address used to access data for an application.

23. The non-transitory computer-readable storage medium of claim 22, wherein the persistent host memory buffer is a byte-addressable write-in-place non-volatile memory.

24. The non-transitory computer-readable storage medium of claim 22, wherein the portion is all of the L2P indirection table.

25. The non-transitory computer-readable storage medium of claim 22, wherein the block addressable non-volatile memory is NAND Flash.
